(19) United States
(12) Patent Application Publication
(10) Pub. No.: US 2024/0055950 A1
(43) Pub. Date: Feb. 15, 2024

(54) ROTATING ELECTRICAL MACHINE

(71) Applicant: Hitachi Industrial Equipment Systems Co., Ltd., Tokyo (JP)

(72) Inventors: Yukinari FUJISAWA, Tokyo (JP); Takuya KAWASHIMA, Tokyo (JP)

(73) Assignee: Hitachi Industrial Equipment Systems Co., Ltd., Tokyo (JP)

(21) Appl. No.: 18/269,333

(22) PCT Filed: Dec. 16, 2021
(86) PCT No.: PCT/JP2021/046650

§ 371 Date: Jun. 23, 2023

(30) Foreign Application Priority Data
Feb. 15, 2021 (JP) 2021-022169

(51) Int. Cl. H02K 9/06; H02K 5/20; H02K 7/00

(52) U.S. Cl. CPC H02K 9/06; H02K 5/207; H02K 7/003; H02K 2205/09

(57) ABSTRACT

Rotating electrical machine comprising: a housing storing a stator and a rotor, a fan cover covers the housing from the outside, an end bracket attached to the axial end face of the housing, a cooling fan installed in the fan cover, wherein output shaft side end face of the fan cover has a convex portion extending in the axial direction, the end bracket on the output shaft side has a concave first exhaust opening part relative to the convex part of the fan cover, the end bracket on the anti-output shaft side has a second exhaust opening part on the opposite side of the first exhaust opening part.

### TECHNICAL FIELD

This invention relates to a rotating electrical machine, and in particular to a cooling structure for a rotating electrical machine.

### BACKGROUND ART

When rotating electrical machines try to achieve high output or torque, their size generally tends to be larger. As the size of rotating electrical machines increases, machinery and equipment in which rotating electrical machines are incorporated also need to be enlarged, so problems such as limited installation space and high cost of machinery and equipment arise.

The expected operation of a rotating electrical machine is obtained by generating torque corresponding to an external load in the drive state.

At this time, copper loss caused by coil energization and iron loss mainly generated inside the iron core due to rotating magnetic flux are generated inside the rotating electrical machine and consumed as heat. The heat generated inside the rotating electrical machine is dissipated from the housing surface by heat conduction.

By quickly removing the exhaust heat of the housing surface, the housing is cooled and the temperature rise inside the rotating electrical machine can be suppressed. Therefore, the size of the rotating electrical machine can be reduced, and the cost can be lowered. In addition, when the same size is used, it is possible to achieve higher output and higher torque. In a permanent magnet type rotating electrical machine, when the temperature rise inside the rotating electrical machine is suppressed, the temperature rise of the permanent magnet is suppressed. Since the resistance to permanent demagnetization of permanent magnets is expanded, it is possible to reduce the thickness of permanent magnets, and further cost reduction can be achieved.

To improve cooling efficiency by exhaust heat from the housing surface, fan driven by other power source is often employed for cooling. The cooling structure is often comprising multiple cooling fans installed on each side of the fan cover that covers the entire side of the rotating electrical machine. Cooling air discharged from the cooling fan passes through the space created between the housing of the rotating electrical machine and the fan cover, quickly exhaust heat from the surface of the housing of the rotating electrical machine, cooling the housing and reducing the temperature rise inside the rotating electrical machine. This cooling process can suppress the temperature rise inside the rotating electrical machine.

Patent document 1 discloses a cooling structure for a rotating electrical machine. In Patent Document 1, multiple cooling fans are arranged in parallel in the axial direction of the rotating electrical machine and installed at a predetermined angle to prevent mutual interference of cooling air discharged from the cooling fans arranged in parallel, thereby improving cooling efficiency.

### CITATION LIST

### Patent Document

Patent Documents 1 Patent Publication No. 2015-220854

### SUMMARY OF THE INVENTION

### Problems to be Solved by the Invention

The structure shown in Patent Literature 1 is designed to prevent mutual interference of cooling air by installing cooling fans at a predetermined angle so that cooling air discharged from multiple cooling fans is directed in the same direction.

However, because of the cooling fans are installed at a predetermined angle, the external dimensions of the rotating electrical machine including the cooling fans become larger, and there is a problem that it is difficult to realize the miniaturization of the rotating electrical machine.

The purpose of the present invention is to provide a rotating electrical machine that improves cooling efficiency by more rapidly exhaust heat from housing surfaces without increasing the external dimensions of the rotating electrical machine.

One preferred example of the invention is a rotating electrical machine comprising: a housing storing a stator and a rotor, a fan cover covers the housing from the outside, an end bracket attached to the axial end face of the housing, a cooling fan installed in the fan cover, wherein output shaft side end face of the fan cover has a convex portion extending in the axial direction, the end bracket on the output shaft side has a concave first exhaust opening part relative to the convex part of the fan cover, the end bracket on the anti-output shaft side has a second exhaust opening part on the opposite side of the first exhaust opening part.

### Effects of the Invention

According to the present invention, the cooling efficiency can be improved by rapidly dissipating heat from the housing surface without increasing the external dimensions of the rotating electrical machine.

### BRIEF DESCRIPTION OF DRAWINGS

FIG. 1 Plan view of the rotating electrical machine of Example 1.

FIG. 2 The figure shows the flow of cooling air in a rotating electrical machine in a comparative example.

FIG. 3 The figure shows the flow of cooling air in FIG. 1.

FIG. 4 The figure shows the cross-sectional shape of the rotating electrical machine in Example 2.

FIG. 5 The figure shows the flow of cooling air when there is no partition plate in FIG. 4.

FIG. 6 Plan view of the rotating electrical machine in Example 3.

FIG. 7 The figure shows the flow of cooling air when there is no partition plate in FIG. 6.

### MODE FOR CARRYING OUT THE INVENTION

### Example 1

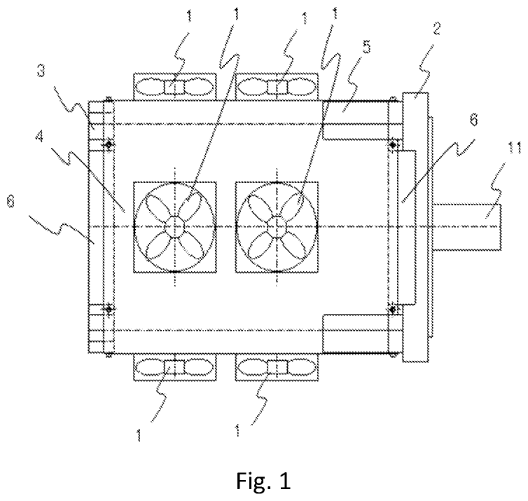

Example 1 is described with FIG. 1. FIG. 1 is a plan view of the rotating electrical machine of Example 1. The structure of the rotating electrical machine shown in Example 1 has a housing 5 storing a stator and a rotor, a fan cover 4 that covers the housing 5 from the outside, end brackets 2, 3 that are attached to the axial end faces of the housing 5, and a cooling fan 1 on the fan cover 4. Output shaft side (load side) end bracket 2 and anti-output shaft side (anti-load side) end bracket 3 with concave-shaped exhaust opening part 6 are located at the axial end of housing 5. A fan cover 4 is installed to cover the entire side of the rotating electrical machine, and each side of the fan cover 4 has a structure in which multiple cooling fans 1 are installed on the same plane. In FIG. 1, two cooling fan 1 are placed on the fan cover 4, which has one rectangular side.

The output shaft side end face of the fan cover 4 has a convex part extending in the axial direction, and the end bracket 2 on the output shaft side has a concave first exhaust opening part 6 in a position relative to the convex part of the fan cover 4.

On the end bracket 3 on the anti-output shaft side, a second exhaust opening part 6 (left side of FIG. 1) is formed on the opposite side relative to the first exhaust opening part 6 (right side of FIG. 1). The multiple cooling fans installed on each side of the fan cover 4 are shown in FIG. 1, two on each side, but are not limited to this.

In this example, when the housing of the rotating electrical machine includes four sides and one side is rectangular, the side surfaces of the housing 5 are arranged in a rectangular fan cover 4 for four surfaces at positions close together via a gap. Cold air from the cooling fan 1 can be efficiently circulated in the gap between housing 5 and fan cover 4. If the shape of the outer diameter of housing 5 is cylindrical, a cylindrical fan cover may be used to enclose housing. The cross-sectional shape of the housing is not limited to a square shape but may be any other polygonal shape.

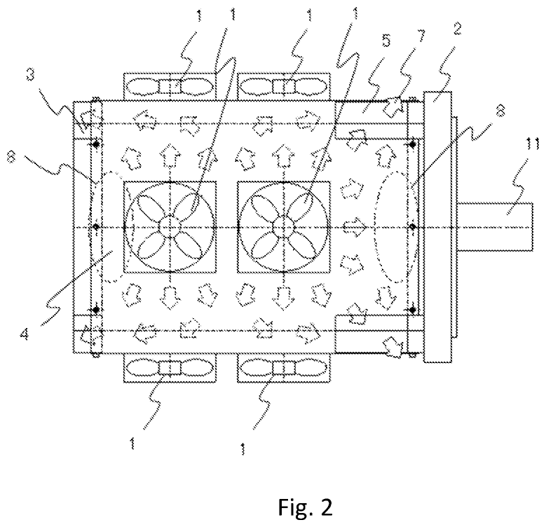

FIG. 2 shows the flow of cooling air 7 in a rotating electrical machine as a comparative example. In the structure of the comparative example, the cooling air 7 discharged from the cooling fan 1 installed to blow on the housing surface of the rotating electrical machine passes through the inner surface of the fan cover 4 and flows through the four openings on the output shaft side of the fan cover 4 and the four corner openings of the anti-output shaft side end bracket 3, which are cut open to install the rotating electrical machine.

However, since the part corresponding to the concave-shaped exhaust opening part 6 on each end bracket in Example 1 is completely shielded from the wind, the ventilation resistance increases at the blockage 8, so the exhaust does not occur quickly, and housing 5 is not sufficiently cooled in the vicinity of the blockage.

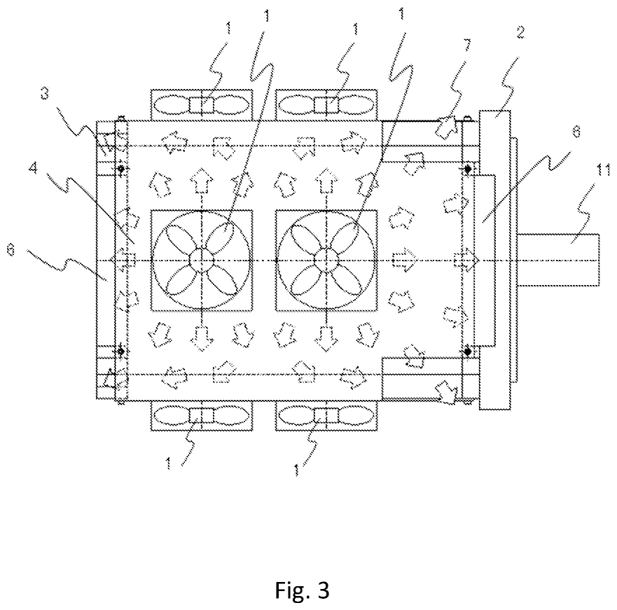

FIG. 3 shows the flow of cooling air in the structure of Example 1 shown in FIG. 1. By providing a concave-shaped exhaust opening part 6 on each end bracket, it is possible to reduce ventilation resistance in the part corresponding to the blockage 8 shown in FIG. 2. Therefore, not only the exhaust of cooling air 7 from the openings at the four corners on the output shaft side of fan cover 4, which is cut open to insert bolts and other fixtures to install the rotating electrical machine, but also more cooling air 7 can pass through the blockage 8 and be exhausted from the exhaust opening part 6.

Therefore, the warmed air in the blockage 8 shown in FIG. 2 is quickly discharged to the outside of the rotating electrical machine, thus accelerating the heat exchange on the housing surface and, in other words, reducing the temperature rise inside the rotating electrical machine.

This example is particularly effective for motors for driving machine tool equipment such as injection molding machines and press machines that require large output and torque.

According to this example, by providing apertures for exhausting cooling air at the axial ends of each side of the rotating electrical machine, cooling efficiency is improved by exhaust heat from the housing surface more quickly, and at the same time, the external dimensions of the rotating electrical machine including the cooling fan, can be avoided.

### Example 2

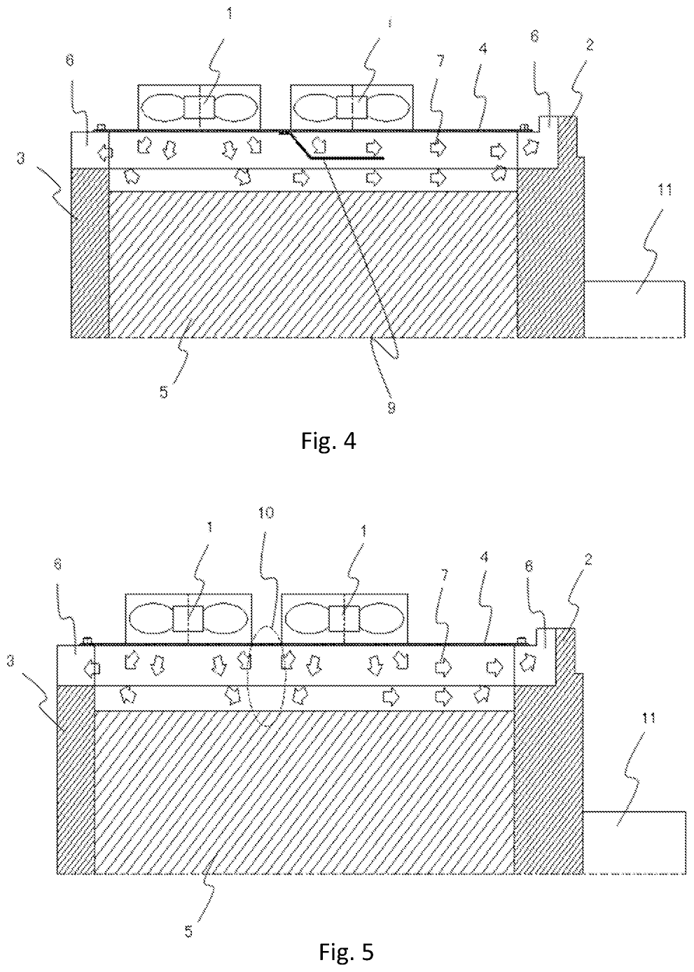

Example 2 will be described with FIG. 4. FIG. 4 shows a cross-sectional view of the rotating electrical machine parallel to the axial direction.

Example 2 shows that a partition plate 9 is provided on the inner surface of the fan cover 4 relative to each of a plurality of cooling fans 1 installed on the outer surface of the fan cover 4, so that cooling air 7 discharged from each cooling fan 1 is directed to the exhaust opening part 6 provided on the output shaft side end bracket 2.

In this example, cooling air from cooling fan 1 passes through the gap between fan cover 4 and housing 5, and the flow paths of cooling air from the first cooling fan and the second cooling fan are shown in FIG. 4. are different flow paths above and below the gap described above, so mutual interference of cooling air 7 is avoided.

FIG. 4 shows a partition plate 9 molded to control the exhaust opening part 6 of the output shaft side end bracket 2, but a partition plate 9 molded to control the exhaust opening part of the anti-output shaft side end bracket 3 can also be used.

FIG. 5 shows the cross-sectional shape of the inner surface of fan cover 4 in FIG. 4 without the partition plate 9. FIG. 5 also shows the cross-sectional shape parallel to the axial direction of the rotating electrical machine in FIG. 1 of Example 1.

Without the partition plate 9, cooling air 7 discharged from multiple cooling fans 1 installed on the outer surface of the fan cover 4 will interfere with each other. Cooling air 7 around the interference zone 10 of cooling air 7 is hard to be discharged to the outside of the rotating electrical machine due to the mutual interference, so the cooling performance of the housing 5 is not sufficient in this area and cooling performance is reduced.

To avoid mutual interference of the cooling air 7, a partition plate 9, which is molded to encourage the exhaust opening part 6 is placed on the inner surface of the fan cover 4 as shown in FIG. 4.

By placing the partition plate 9, the cooling air 7 discharged from the cooling fan 1 located on the output shaft side passes near the inner surface of the fan cover 4, and the cooling air 7 discharged from the cooling fan 1 located on the anti-output shaft side passes near the housing surface of the rotating electrical machine.

Cooling air 7 passing through partition 9 merges and is discharged from exhaust opening part 6. In other words, the placement of partition 9 avoids mutual interference of the cooling air 7, enabling the warmed air near the surface of housing 5 to be quickly discharged to the outside of the rotating electrical machine, thereby improving the cooling efficiency.

### Example 3

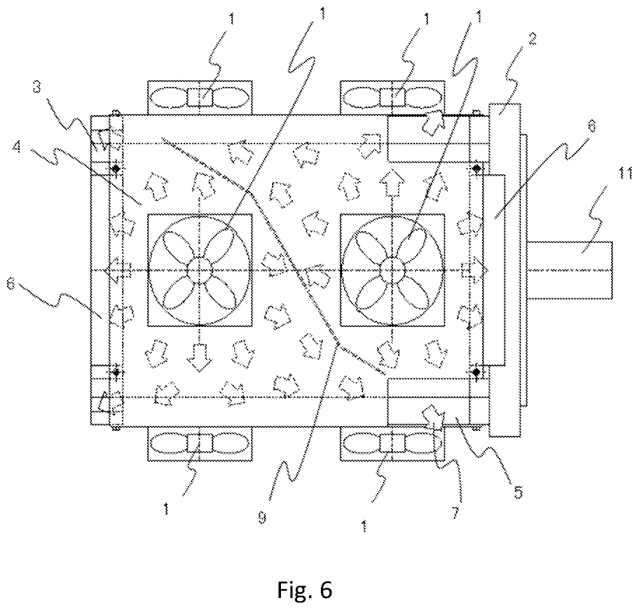

Example 3 will be described with FIG. 6. FIG. 6 is a plan view of the rotating electrical machine of Example 3. Example 3 is a structure in which a partition plate 9 is provided at a position on the inner surface of the fan cover 4 relative to a plurality of cooling fans 1 installed on the outer surface of the fan cover 4.

In this example, partition plate 9 is arranged for cooling air from cooling fan 1 passes through the gap between fan cover 4 and housing 5 and is divided into cooling air from the first cooling fan located on the output shaft side and cooling air from the second cooling fan located on the anti-output shaft side. By arranging the partition plate 9, mutual interference of cooling air 7 is avoided.

The partition plate 9 in Example 3 is arranged so that the cooling air 7 discharged from the cooling fan 1 located on the anti-output shaft side and control toward the output shaft side is control into the predetermined openings on the output shaft side cut in the four corners of the fan cover 4.

On the other hand, the cooling air 7 discharged from the cooling fan 1 located on the output shaft side and control toward the anti-output shaft side is arranged to be control to the predetermined openings on the four corners of the anti-output shaft side end bracket 3.

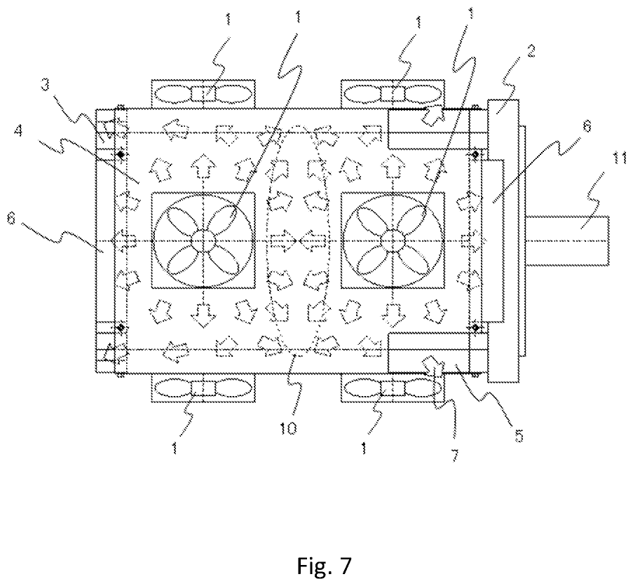

FIG. 7 shows the case without the partition plate 9 on the inner surface of fan cover 4 in FIG. 6 (Example 3). In the case without partition plate 9, cooling air 7 discharged from multiple cooling fans 1 installed on the outer surface of fan cover 4 interfere with each other.

Since the warmed air near the interference area 10 of the cooling air 7 is hard to discharge to the outside of the rotating electrical machine, the cooling performance of the housing 5 is not sufficient in this area, and the cooling performance is reduced.

To avoid mutual interference of cooling air 7, partition plate 9 is placed on the inner surface of fan cover 4 as shown in FIG. 6.

Cooling air 7 near the interference portion 10 discharged from the cooling fan 1 located on the output shaft side is discharged along the partition plate 9 to the four corner openings of the anti-output shaft side end bracket 3.

On the other hand, the cooling air 7 around the interference area 10 discharged from the cooling fan 1 located on the anti-output shaft side is similarly discharged from the openings in the four corners of the fan cover 4 on the output shaft side.

In other words, the placement of partition plate 9 avoids mutual interference of cooling air 7, enabling warmed air near the housing 5 surface to be quickly discharged to the outside of the rotating electrical machine, thereby improving the cooling efficiency.

According to this example, the height of the cooling air between fan cover 4 and housing 5 can be lowered compared to Example 2, and the outer diameter of the rotating electrical machine can be reduced by that amount.

### REFERENCE SIGNS LIST

1: Cooling fan Cooling fan
2: Output shaft side end bracket
3: Anti-output shaft side end bracket
4: Fan Cover Fan Cover
5: Housing housing
6: Exhaust opening part
7: Cooling air
8: Blockage of cooling air
9: Divider on the inner surface of the fan cover
10: Interference part of cooling air
11: Output shaft Output shaft

1. Rotating electrical machine comprising:
a housing storing a stator and a rotor,
a fan cover covers the housing from outside,
an end bracket attached to the axial end face of the housing,
a cooling fan on the fan cover,
wherein output shaft side end face of the fan cover has a convex portion extending in the axial direction,
the end bracket on the output shaft side has a concave first exhaust opening part relative to the convex part of the fan cover,
the end bracket on the anti-output shaft side has a second exhaust opening part on the opposite side of the first exhaust opening part.

2. Rotating electrical machine according to claim 1 comprising:
plurality of cooling fans are arranged on the same surface of the fan cover.

3. Rotating electrical machine according to claim 2 comprising:
cooling air from the cooling fan passes through the gap between the fan cover and the housing, and the flow paths of cooling air from the first cooling fan and the second cooling fan are different.

4. Rotating electrical machine according to claim 2 comprising:
cooling air from the cooling fan passes through the gap between the fan cover and the housing,
comprising a partition to separate the cooling air from the first cooling fan located on the output shaft side and the cooling air from the second cooling fan located on the anti-output shaft side.

5. Rotating electrical machine according to claim 1 comprising:
the fan cover is rectangular, in which openings are formed at the four corners of the rectangle.
